(19) United States
(12) Patent Application Publication
(10) Pub. No.: US 2024/0147960 A1
(43) Pub. Date: May 9, 2024

(54) Facial Scrubbing Device or Beauty Brush

(71) Applicant: Artin Hayrapetian, Porter Ranch, CA (US)

(72) Inventor: Artin Hayrapetian, Porter Ranch, CA (US)

(21) Appl. No.: 18/387,078

(22) Filed: Nov. 6, 2023

Related U.S. Application Data
(60) Provisional application No. 63/423,213, filed on Nov. 7, 2022.

(51) Int. Cl. A01K 13/00; A46B 5/02; A46B 9/06

(52) U.S. Cl. CPC A01K 13/002; A46B 5/02; A46B 9/06; A46B 2200/10

(57) ABSTRACT

A beauty brush includes a brush body, the brush body having a bristle area on a front side, wherein a first group of bristles in the bristle area may have a first length and a second group of bristles in the bristle area may have a second length; and a handle, a top side of the handle being connected to a bottom side of the brush body. In the beauty brush, individual bristles of the first group of bristles may be interwoven or interspersed within individual bristles of the second group of bristles.

### RELATED APPLICATIONS

This application claims priority to U.S. provisional patent application Ser. No. 63/423,213, filed Nov. 7, 2022, the entirety of which is incorporated herein by reference.

### BACKGROUND

There is a need for a facial scrubbing device or beauty brush for pets, such as dogs, cats and horses, as well as other animals. There are no current products that meet the needs of pet owners.

### BRIEF DESCRIPTION OF THE DRAWINGS

A better understanding of the features, advantages and principles of the present disclosure will be obtained by reference to the following detailed description that sets forth illustrative embodiments, and the accompanying drawings of which:

FIG. 1 illustrates three pet facial scrubbing devices or beauty brush which may be a kit 100 according to some embodiments;

FIG. 2 illustrates a representative pattern of bristles according to some embodiments;

FIG. 3A illustrates dimensions of a tear-shaped bristle area according to embodiments;

FIG. 3B illustrates dimensions of an oval-shaped bristle area according to embodiments;

FIG. 3C illustrates dimensions of a rectangular-shaped bristle area according to embodiments;

FIG. 4A illustrates a top view of a tear-shaped facial scrubbing device or beauty brush according to some embodiments;

FIG. 4B illustrates a back view of a tear-shaped facial scrubbing device or beauty brush according to some embodiments;

FIG. 4C illustrates a side view of a facial scrubbing device or beauty brush according to some embodiments;

FIG. 4D illustrates a front view of a facial scrubbing device or beauty brush according to some embodiments;

FIG. 4E illustrates a side perspective rendering of a tear-shaped facial scrubbing device or beauty brush according to some embodiments;

FIG. 5A illustrates a front right perspective view of the tear-shaped facial scrubbing device or beauty brush according to some embodiments;

FIG. 5B illustrates a back right perspective view of the tear-shaped facial scrubbing device or beauty brush according to some embodiments;

FIG. 5C illustrates a side view of the tear-shaped facial scrubbing device or beauty brush according to some embodiments;

FIG. 5D illustrates a front view of the tear-shaped facial scrubbing device or beauty brush according to some embodiments;

FIG. 6A illustrates a facial scrubbing device or beauty brush including multiple sizes of bristles according to some embodiments; and

FIG. 6B illustrates a facial scrubbing device or beauty brush including areas with different bristle sizes according to some embodiments.

### DETAILED DESCRIPTION

The following detailed description provides a better understanding of the features and advantages of the subject matter described in the present disclosure in accordance with the embodiments disclosed herein. Although the detailed description includes many specific embodiments, these are provided by way of example only and should not be construed as limiting the scope of the subject matter disclosed herein.

The facial scrubbing apparatus or device (or beauty brush) described herein may include a handle and a bristle area. In some embodiments, the bristle area may include long bristles, short bristles and a body to which the long and short bristles are attached and/or connected. The long bristles and the short bristles may vary in length. In some embodiments, the long bristles may be used to remove tear stains from facial regions of pets such as dogs or cats. In some embodiments, the short bristles maybe used to remove saliva stains from facial regions of dogs or cats. In some embodiments, the facial scrubbing apparatus or device (or beauty brush) may be utilized to clean around the eye area, the facial area and the snout area of pets. In some embodiments, the beauty brush may also be referred to as a tear stain remover. In some embodiments, the brush may be referred to as a saliva stain remover.

In some embodiments, the different components of the facial scrubbing apparatus or device (or beauty brush) may be made of bio-compatible liquid silicone rubber (LSR). In alternative embodiments, the facial scrubbing apparatus may be made of other types of rubber, may be made of plastic, or may be made of compounded plastic.

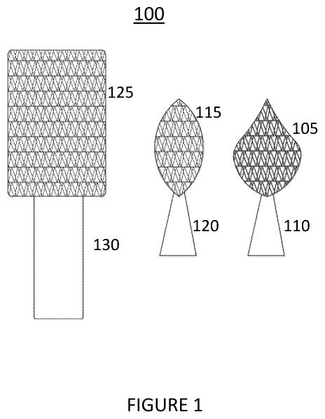

In some embodiments, a kit may include a plurality of facial scrubbing devices or beauty brushes for a pet owner to utilize. For example, FIG. 1 illustrates three pet facial scrubbing devices or beauty brushes which may be a kit 100 according to some embodiments. As an example, a first pet facial scrubbing device or beauty brush 100 may include a tear-shaped bristle area 105 and a first handle 110. Additionally, a second pet facial scrubbing device or beauty brush may include an oval-shaped bristle area 115 and a second handle 120. Further, a third pet facial scrubbing device or beauty brush may include a rectangular-shaped bristle area 125 and a third handle 130. The brushes may be different in size to handle different types of pets and/or different sizes of pets. The different brushes may also be utilized on different areas of the pet, such as around the eyes, the snout, and/or the body.

In some embodiments, the first handle 110, the second handle 120 and/or the third handle 130 may be made or comprised of a bio compatible liquid silicone rubber (LSR). In alternative embodiments, the first handle 110, the second handle 120 and/or the third handle 130 may be made or comprised of Thermoplastic polyurethane (TPU), thermoplastic vulcanizate (TPV), Silicone Masterbatch, Pebax or Thermoplastic elastomers (TPE), or a combination thereof.

In some embodiments, the tear-shaped bristle area 105, the oval-shaped bristle area 115, and/or the rectangular-shaped bristle area 125 may be made of or comprised of a biocompatible LSR. In alternative embodiments, the tear-shaped bristle area 105, the oval-shaped bristle area 115, and/or the rectangular-shaped bristle area 125 may be made of or comprised of Thermoplastic polyurethane (TPU), thermoplastic vulcanizate (TPV), Silicone Masterbatch, Pebax or Thermoplastic elastomers (TPE), or a combination thereof. In some embodiments, the tear-shaped bristle area 105, the oval-shaped bristle area 115, and/or the rectangular-shaped bristle area 125 may include short bristles (e.g., for scrubbing purposes) and long bristles (for fine combing purposes).

In some embodiments, any one of the pet facial scrubbing devices or beauty brush may be utilized to scrub away debris or buildup around the eyes of a pet. In some embodiments, any one of the facial scrubbing devices or beauty brushes illustrated in FIG. 1 may be utilized to comb away debris and build up around the snout of a pet. Specifically, because of the LSR composition of the facial scrubbing devices or beauty brushes, the pet facial scrubbing devices or beauty brushes may be used to comb and/or scrub the sensitive areas around the eyes and the snout of a pet and may not allow any discomfort. In some embodiments, any one of the facial scrubbing devices or beauty brushes may be utilized with a cleansing liquid or substance. In some embodiments, the cleansing liquid or substance may be water, tear free soap and/or a proprietary wink-away or debris removal solution.

The shape of the bristle area may be utilized on different pets or animals and/or may be utilized for different purposes. In some embodiments, for example, the first bristle area 105 may be tear-shaped and the tear-shape may be utilized around the pet's eye area in order to access this delicate area. In some embodiments, for example, the second bristle area 115 may be oval-shaped and may be utilized in the mouth and snout of the pets. In some embodiments, for example, the third bristle area 125 may be square or rectangular-shaped. In some embodiments, the square or rectangular shape may be utilized on larger animals or pets (e.g., large dogs and/or horses) and/or also may be utilized on the mouth or snout of any pets.

In some embodiments, the bristle areas of the facial scrubbing devices or beauty brushes may be completely around a surface of a body underneath. In other embodiments, the bristle areas of the facial scrubbing devices or beauty brushes may be around 50 to 75 percent of a surface of a body underneath with the remaining surface of the body being a smooth surface and having no bristles.

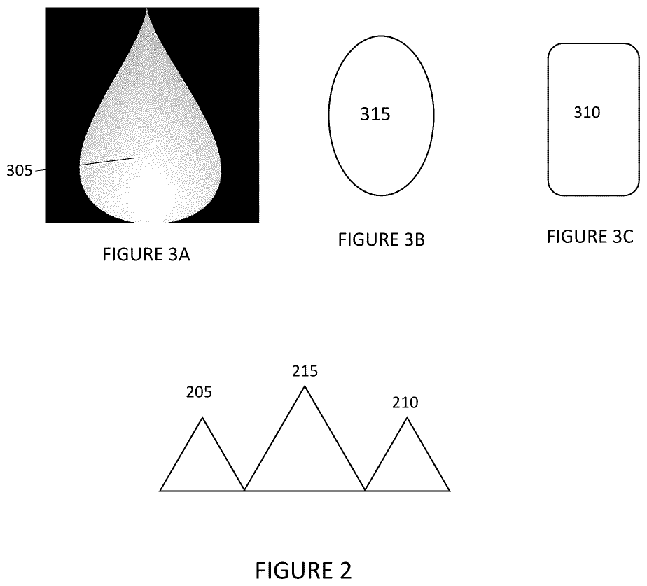

FIG. 2 illustrates a representative pattern of bristles according to some embodiments. In some embodiments, long bristles may be inserted between short bristles. FIG. 2 illustrates long bristle 215 inserted between two short bristles 205 and 210. In some embodiments, this pattern may be repeated for the whole bristle area where no two short bristles are next to each other. In other embodiments, this pattern may be repeated for a whole row and thus each row of the bristle area may have such a pattern. In some embodiments, a first portion of a bristle area (e.g., bristle areas 105 115 or 125) may have short bristles and a second portion of a bristle area may have long bristles. The location and/or frequency of the long and short bristles may be any combination and the scope of the claimed subject matter should not be limited by what is disclosed herein.

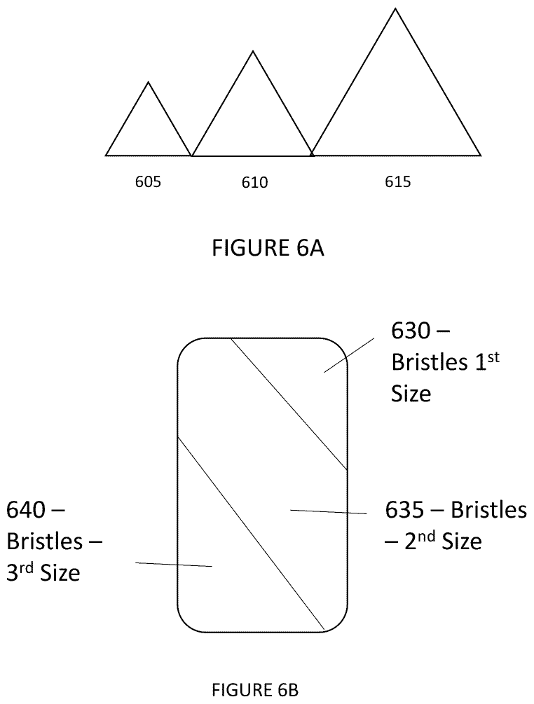

In some embodiments, the short bristles may have a length of approximate 0.1 inches. In some embodiments, the length of the short bristles 205 and 210 may range from 0.05 to 0.15 inches, or alternatively may range from 0.05 to 0.5 inches. In some embodiments, the length of the long bristles 215 may be approximately 0.15 inches. In some embodiments, the length of the long bristles 215 may range from 0.1 inches to 0.25 inches, or alternatively may range from 0.05 to 0.5 inches. In some embodiments, there may be a variety of bristle lengths (e.g., there could be three, four and/or five bristle lengths) in the same bristle area. FIG. 6A illustrates three bristle lengths that may be utilized in a bristle area of a beauty brush according to some embodiments. In some implementations, a first bristle 605 may have one length, a second bristle 610 may have a second length that is longer than a first length, and a third bristle 615 may have a third length that is longer than a first length and a second length. The different bristle lengths in FIG. 6A may be adjacent to each other or in an alternative embodiment, may be in separate bristle areas. In these embodiments, a pattern for the variety of bristle lengths may include a number of different combinations, including, but not limited to all or most bristle lengths of one size being in a same area or the different bristle lengths being interspersed with each other, e.g., bristles with different lengths may be adjacent to each other vertically and/or horizontally. As another example, the bristle area of a beauty brush may have different areas with different sizes of bristles. FIG. 6B illustrates a bristle area of a beauty brush having three different bristle sizes: bristle area 630 having a first size; bristle area 635 having a second sizes different from the first size; and bristle area 640 having a third size different from a second size and a first size. Other patterns besides the diagonal pattern as shown in FIG. 6B may also be utilized for the beauty brush or facial scrubbing devices.

FIG. 3A illustrates shapes or dimensions of a tear-shaped bristle area according to embodiments. FIG. 3B illustrates dimensions of an oval-shaped bristle area according to embodiments. FIG. 3C illustrates dimensions of a rectangular-shaped bristle area according to embodiments. The tear-dropped shaped bristle area 305 of FIG. 3A may have a maximum width of 2.5 inches near a bottom of the tear drop and a height of 3.0 inches. In some embodiments, the tear-dropped shaped bristle area 305 may have a width ranging from 0.2 inches (near the top) to 3.5 inches, or alternatively the width may range from 0.2 inches to 6 inches. In some embodiments, the tear-dropped shaped bristle area 305 may have a height ranging from 2 inches to 3.5 inches, or alternatively may have a height ranging from 0.5 inches to 6 inches. The oval-shaped bristle area 315 of FIG. 3B may have a height diameter of 2.5 inches and may have a width diameter of 1.5 inches. In some embodiments, the oval-shaped bristle area 315 may have a height diameter ranging from 2.0 inches to 3.0 inches (or alternatively may have a height diameter ranging from 0.5 inches to 6.0 inches) and may have a width diameter ranging from 1.0 inches to 2.0 inches (or alternatively may have a width diameter ranging from 0.5 inches to 4.0 inches). The rectangular-shaped bristle area 315 of FIG. 3C may have a width of 2.5 inches and may have a height of 3.5 inches. In some embodiments, the rectangular-shaped bristle area 315 may have a width ranging from 2.0 inches to 3.0 inches (or alternatively a width ranging from 0.5 inches to 6 inches) and may have a height ranging from 3.0 inches to 4.0 inches (or alternatively a height ranging from 1 inch to 6.5 inches).

In some embodiments, the facial scrubbing devices or beauty brushes may be created utilizing an injection mold tool (shaped with the necessary bristle area (e.g., tear drop, oval, or rectangular)) and bio compatible LSR material. In some embodiments, the facial scrubbing devices or beauty brushes may be created using an injunction molding process followed by a dip coating process. In some embodiments, the handles of the facial scrubbing devices or beauty brushes may include a stiffener in the shape of a spoon, for example. In some embodiments, the stiffener may be made of steel, flame retardant level 4 glass epoxy laminate (fr4), plastic, and/or Delrin. In some embodiments, the shape of the spoon allows easy handling by the user.

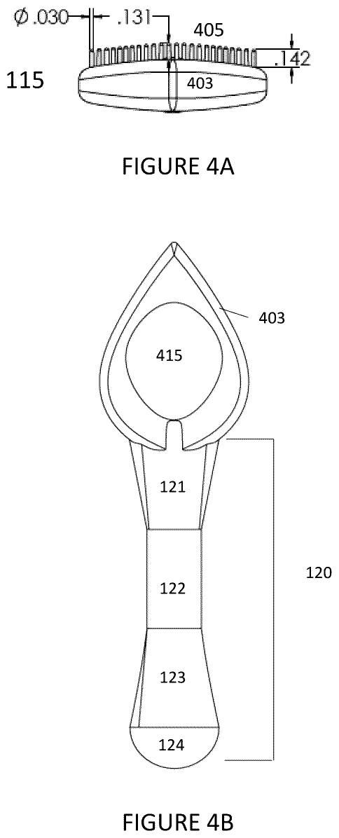

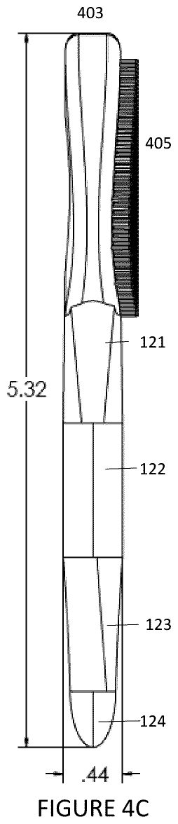

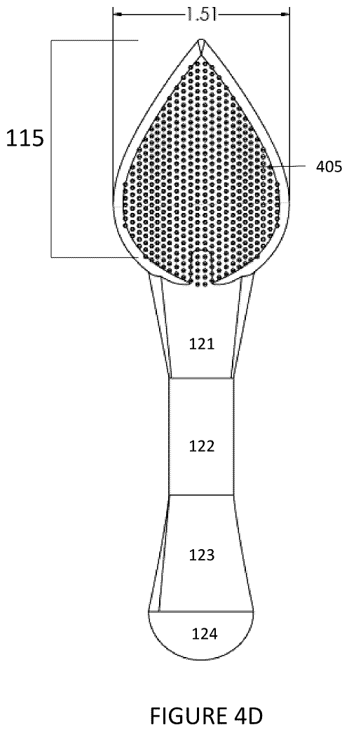

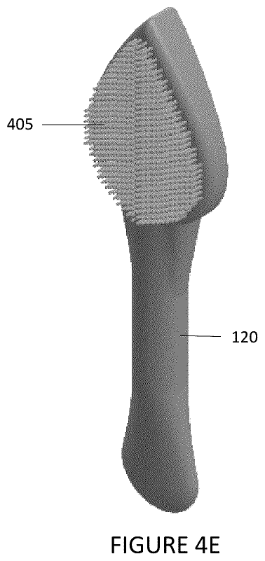

FIG. 4A illustrates a top view of a tear-shaped facial scrubbing device or beauty brush according to some embodiments. FIG. 4B illustrates a back view of a tear-shaped facial scrubbing device or beauty brush according to some embodiments. FIG. 4C illustrates a side view of a facial scrubbing device or beauty brush according to some embodiments. FIG. 4D illustrates a front view of a facial scrubbing device or beauty brush according to some embodiments. FIG. 4E illustrates a side perspective rendering of a tear-shaped facial scrubbing device or beauty brush according to some embodiments. As illustrated in FIG. 4A, a tear-shaped bristle area 115 may include a bristle area body 403 and a plurality of bristles 405. As illustrated, in some embodiments, a radius of the plurality of bristles may be 0.131 inches or the radius may range from 0.100 inches to 0.151 inches. In some embodiments, a width of an individual bristle may be 0.030 inches or may range from 0.025 to 0.035 inches in width. In some embodiments, a height of an individual bristle may be 0.142 inches or may range from 0.125 to 0.165 inches in height. As discussed previously, the length of the individual bristles of the plurality of bristles may vary in length and may vary in pattern. In FIG. 4B, the tear-shaped facial scrubbing device is shown from the back. In some embodiments, the tear-shaped facial scrubbing device or beauty brush may include a bristle area body 403 (including a thumb or finger placement area 415) and a handle 120 may include a number of parts. In some embodiments, the handle 120 may include a top section 121, a middle section 122, a bottom section 123 and/or a base section 124. In some embodiments, the top section 121 of the facial scrubbing device or beauty brush handle 120 may be tapered in shape. In some embodiments, the middle section 122 of the facial scrubbing device handle 120 may have straight edges. In some embodiments, the bottom section 123 of the facial scrubbing device or beauty brush handle 120 may be tapered. In some embodiments, the base section 124 of the facial scrubbing device or beauty brush handle 120 may have a curved or rounded portion. In some embodiments, a facial scrubbing device or beauty brush may have a height of approximately 5.32 inches or may range from 5.0 inches to 5.7 inches in height, or alternatively, the height may range from 4 inches to 8 inches. In some embodiments, a facial scrubbing device or beauty brush may have a thickness of approximately 0.44 inches or may range from 0.4 inches to 0.5 inches in thickness. In alternative embodiments, the thickness of the facial scrubbing device or beauty brush may range from 0.2 inches to 1.0 inches.

FIG. 4D illustrates a front view of a facial scrubbing device or beauty brush and shows a width of the bristle area 115 being approximately 1.51 inches or may range from 1.4 to 1.6 inches in width. In alternative embodiments, the width of the bristle area may range from 1.0 inches to 2.2 inches. FIG. 4E illustrates a side perspective view of the plurality of bristles 405 and the handle 120 of the beauty brush.

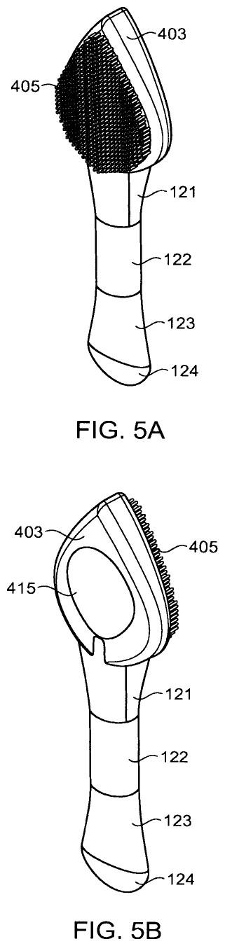

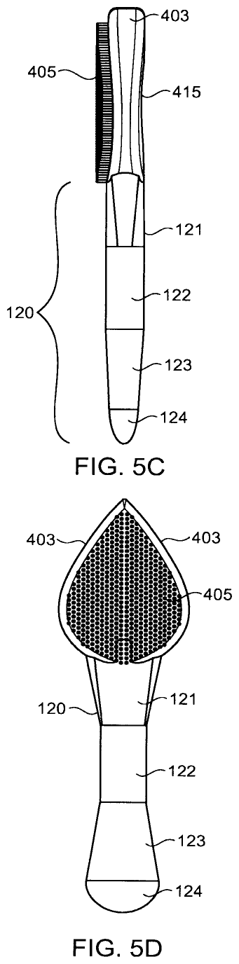

FIG. 5A illustrates a front right perspective view of the tear-shaped facial scrubbing device or beauty brush according to some embodiments. FIG. 5B illustrates a back right perspective view of the tear-shaped facial scrubbing device or beauty brush according to some embodiments. FIG. 5C illustrates a side view of the tear-shaped facial scrubbing device or beauty brush according to some embodiments. FIG. 5D illustrates a front view of the tear-shaped facial scrubbing device or beauty brush according to some embodiments. In some embodiments, the tear-shaped facial scrubbing device or beauty brush in FIGS. 5A-5D may include a bristle area (including the plurality of bristles 405, a thumb placement area 415, and the bristle area body 403), and a facial scrubbing device or beauty brush handle 120 (including a top section 121, a middle section 122, a bottom section 123 and/or a base section 124).

In addition, a unique facial scrubbing solution may also be utilized with the new improved facial scrubbing device or beauty brush. In some embodiments, the facial scrubbing solution may include one or more oils and/or one or more acids. In some embodiments, the facial scrubbing solution may include combinations or concentrations of the following acids or oils is a variety of different formulations: HOCl—Hyplochlorous Acid, Jojoba Oil, Coconut Oil and/or Colloidal Silver. In some embodiments, the facial scrubbing solution may also include combinations and/or concentrations of the following additional acids and oils in a variety of different formulations: Vitamin E and Boric acid.

In some embodiments, the facial scrubbing device or beauty brush may include bristles on a back side of the body 403. In other words, rather than a finger placement area, the back side of the body 403 may include a bristle area where another plurality of bristles may be located. This would be in an area where the thumb placement area 415 is located for example in FIG. 5B. In some embodiments, the plurality of bristles on a back side of the body 403 may be utilized for scrubbing and/or additional cleaning.

In some embodiments, the bristles may be made of a plastic, a hard plastic, a rubber substance. In some embodiments, the bristles may be made of a bio compatible liquid silicone rubber (LSR). In some embodiments, the bristles may be made of a Thermoplastic polyurethane (TPU), thermoplastic vulcanizate (TPV), Silicone Masterbatch, Pebax or Thermoplastic elastomers (TPE), or a combination thereof.

In some embodiments, the facial scrubbing device or beauty brush may include a hood or a finger placement device. In some embodiments, the hood or finger placement device may be located or positioned at a tip (or top) of the tear shaped bristle area or bristle area body. In some embodiments, the hood may allow for finger placement at a tip of a tear-drop shaped bristle area body in order to allow the user to stabilize the beauty brush or facial scrubbing device during use and/or to increase a force applied by the beauty brush or facial scrubbing device on the pet or animal.

A person of ordinary skill in the art will recognize that any process or method disclosed herein can be modified in many ways. The process parameters and sequence of the steps described and/or illustrated herein are given by way of example only and can be varied as desired.

For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or comprise additional steps in addition to those disclosed. Further, a step of any method as disclosed herein can be combined with any one or more steps of any other method as disclosed herein.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and shall have the same meaning as the word “comprising.

As used herein, the term “or” is used inclusively to refer items in the alternative and in combination.

As used herein, characters such as numerals refer to like elements.

Embodiments of the present disclosure have been shown and described as set forth herein and are provided by way of example only. One of ordinary skill in the art will recognize numerous adaptations, changes, variations and substitutions without departing from the scope of the present disclosure. Several alternatives and combinations of the embodiments disclosed herein may be utilized without departing from the scope of the present disclosure and the inventions disclosed herein. Therefore, the scope of the presently disclosed inventions shall be defined solely by the scope of the appended claims and the equivalents thereof.

1. A beauty brush, comprising:
a brush body, the brush body having a bristle area on a front side, wherein a first group of bristles in the bristle area may have a first length and a second group of bristles in the bristle area may have a second length; and
a handle, a top side of the handle being connected to a bottom side of the brush body.

2. The beauty brush of claim 1, wherein individual bristles of the first group of bristles may be interwoven or interspersed within individual bristles of the second group of bristles.

3. The beauty brush of claim 1, wherein the first group of bristles may be in a first section of the bristle area and the second group of bristles may be in a second section of the bristle area.

4. The beauty brush of claim 1, wherein a back side of the brush body may include a finger or thumb placement area configured to allow a user to place a thumb or finger thereon to control use of the beauty brush.

5. The beauty brush of claim 1, wherein a back side of the brush body may include another bristle area, the another bristle area include a plurality of bristles configured to further clean a pet.

6. The beauty brush of claim 5, wherein a third group of bristles in the another bristle area may have a third length and a fourth group of bristles in the another bristle area may have a fourth length, the third length and the fourth length being different.

7. The beauty brush of claim 1, wherein the handle may include a stiffener in shape of a spoon.

8. The beauty brush of claim 1, wherein the first group of bristles and the second group of bristles covers all or substantially all of the bristle area.

9. The beauty brush of claim 1, wherein the first group of bristles and the second group of bristles covers between 50 to 80 percent of the bristle area.

10. The beauty brush of claim 1, wherein the handle includes a top section, a middle section, a bottom section and a base section.

11. The beauty brush of claim 10, wherein the top section of the handle is tapered in shape, the middle section of the handle has straight side edges, the bottom section of the handle is tapered and the base section of the handle may have a curved or rounded shape on a side and bottom of the base section.

12. The beauty brush of claim 1, further including a hood or finger placement device positioned on a top of the brush body and configured to allow a user's finger to stabilize the beauty brush.
